(19) United States
(12) Patent Application Publication
(10) Pub. No.: US 2021/0090116 A1
(43) Pub. Date: Mar. 25, 2021

(54) COMPUTING DEVICE AND METHOD FOR IDENTIFYING AND VALIDATING DISCOUNTS OF A PRODUCT IN A TRANSACTION

(71) Applicant: McKesson Corporation, Irving, TX (US)

(72) Inventor: Allan MARKS, Alpharetta, GA (US)

(21) Appl. No.: 16/577,657

(22) Filed: Sep. 20, 2019

(51) Int. Cl. G06Q 30/02; G06Q 20/12

(52) U.S. Cl. CPC G06Q 30/0239; G06Q 20/12

(57) ABSTRACT

Provided herein is a computer program product, apparatus, and method for processing electronic transaction request messages based upon an analysis of the message. Methods may include: analyzing and parsing the electronic transaction request message for information associated with the electronic transaction request; identifying a discount applied to the transaction request based on the information associated with the electronic transaction request; validating application of the discount to the electronic transaction request based on rules established for the electronic transaction request; storing a transaction record of the application of the discount to the electronic transaction request; mapping fields from the electronic transaction request to a standard format; generating a discount payment request report to accompany an invoice to a manufacturer; receiving payment for the discount from the manufacturer; and providing payment of the discount to the first party.

### TECHNOLOGICAL FIELD

An example embodiment of the present invention relates generally to validating a discount applied to a transaction of an electronic transaction request message, and more particularly, to ensuring the consumer receives full benefit of an available discount for a product requested in an electronic transaction request message and that a retailer receives compensation for the discount.

### BACKGROUND

Products that are sold from retail outlets are often manufactured or distributed by other entities. Often, the manufacturer or distributor may offer discounts on the price of the product, which may be available to a consumer of the product. However, this price may not be visible to the retailer such that the retailer may not provide the discounted price to a consumer. This may result in a lost sale, or a person failing to purchase a needed product due to a price that is actually higher than a discounted price that may be available. Further, in industries such as healthcare, entities other than the manufacturer and retailer may be involved, such as a benefits provider which may influence the price to the consumer, and the portion of the price for which the consumer is responsible. Complex pricing models may exacerbate the issue and result in varying prices across different retailers for the same product.

### BRIEF SUMMARY

A computing device, method and computer program product are provided in accordance with an example embodiment in order to process electronic transaction request messages based upon an analysis of the message. The computing device of some embodiments may include: a communication interface configured to receive the electronic transaction request message from a first party for a product. The processing circuitry may be configured to: analyze and parse the electronic transaction request message for information associated with the electronic transaction request; identify a discount applied to the transaction request based on the information associated with the electronic transaction request; validate application of the discount to the electronic transaction request based on rules established for the electronic transaction request; store a transaction record of the application of the discount to the electronic transaction request; map fields from the electronic transaction request to a standard format; generate a discount payment request report to accompany an invoice to a manufacturer; receive payment for the discount from the manufacturer; and provide payment of the discount to the first party.

The processing circuitry configured to generate the discount payment request report may include processing circuitry configured to aggregate a plurality of transaction records and respective discounts and generate an aggregated discount payment request report to accompany an invoice for the plurality of transaction records to the manufacturer. The processing circuitry configured to provide payment of the discount to the first party may include processing circuitry configured to provide payment of the plurality of discounts to the first party including a remittance report associating the discounts of the plurality of discounts to the respective transaction records. The processing circuitry to identify the discount applied to the transaction request may include processing circuitry configured to identify a discount within an adjudicated transaction request message. The first party may be a pharmacy, and the information associated with the electronic transaction request message may include at least one of a National Drug Code (NDC), pharmacy identifier, or contract identifier.

The processing circuitry configured to validate application of the discount to the electronic transaction request based on rules established for the electronic transaction request may include processing circuitry configured to: establish if the discount has been applied according to rules established by the manufacturer; identify violations of the rules established by the manufacturer; and reverse the electronic transaction request message in response to the identification of violations of the rules established by the manufacturer, where the reversal of the electronic transaction request includes generation of a rejection response specifying the error condition. The rejection response specifying the error condition may include an indication of how the error may be resolved. The processing circuitry configured to map fields from the electronic transaction request to a standard format may include processing circuitry configured to map fields from the electronic transaction request to National Council for Prescription Drug Programs (NCPDP) manufacturer rebate standard format. The discount identified may be a primary discount, where the processing circuitry may further be configured to: process a secondary discount payment against the electronic transaction request; and generate a report to reconcile the primary discount payment and the secondary discount payment with the first party.

Embodiments provided herein may include a computer program product to analyze an electronic transaction request message. The computer program product may include a non-transitory computer-readable storage medium having program code instructions stored thereon. The program code instructions may include program code instructions configured, upon execution, to: analyze and parse the electronic transaction request message for information associated with the electronic transaction request; identify a discount applied to the transaction request based on the information associated with the electronic transaction request; validate application of the discount to the electronic transaction request based on rules established for the electronic transaction request; store a transaction record of the application of the discount to the electronic transaction request; map fields from the electronic transaction request to a standard format; generate a discount payment request report to accompany an invoice to a manufacturer; receive payment for the discount from the manufacturer; and provide payment to the first party.

The program code instructions to generate the discount payment request report may include program code instructions to aggregate a plurality of transaction records and respective discounts and generate an aggregated discount payment request report to accompany an invoice for the plurality of transaction records to the manufacturer. The program code instructions to provide payment of the discount to the first party may include program code instructions to provide payment of the plurality of discounts to the first party including a remittance report associating the discounts of the plurality of discounts to respective transaction records. The program code instructions to identify the discount applied to the transaction request may include program code instructions to identify a discount within an adjudicated transaction request message. The first party may be a pharmacy, where the information associated with the electronic transaction request message may include at least one of a National Drug Code (NDC), a pharmacy identifier, or a contract identifier.

The program code instructions to validate application of the discount to the electronic transaction request based on rules established for the electronic transaction request may include program code instructions to: establish if the discount has been applied according to rules established by the manufacturer; identify violations of the rules established by the manufacturer; and reverse the electronic transaction request message in response to the identification of violations of the rules established by the manufacturer, where the reversal of the electronic transaction request includes generating a rejection response specifying the error condition. The rejection response may specify the error condition and provide an indication of how the error condition may be resolved. The program code instructions to map fields from the electronic transaction request to a standard format may include program code instructions to map fields from the electronic transaction request to National Council for Prescription Drug Programs (NCPDP) manufacturer rebate standard format. The discount may be identified as a primary discount. The computer program product may include program code instructions configured to: process a secondary discount payment against the electronic transaction request; and generate a report to reconcile the primary discount payment and the secondary discount payment with the first party.

Embodiments provided herein may include a method for processing electronic transaction request messages based upon an analysis of the message. Methods may include: analyzing and parsing the electronic transaction request message for information associated with the electronic transaction request; identifying a discount applied to the transaction request based on the information associated with the electronic transaction request; validating application of the discount to the electronic transaction request based on rules established for the electronic transaction request; storing a transaction record of the application of the discount to the electronic transaction request; mapping fields from the electronic transaction request to a standard format; generating a discount payment request report to accompany an invoice to a manufacturer; receiving payment for the discount from the manufacturer; and providing payment of the discount to the first party. Generating the discount payment request report may include aggregating a plurality of transaction records and respective discounts and generating an aggregated discount payment request report to accompany an invoice for the plurality of transaction records to the manufacturer.

### DESCRIPTION OF THE DRAWINGS

Having thus described certain embodiments of the invention in general terms, reference will now be made to the accompanying drawings, which are not necessarily drawn to scale, and wherein:

FIG. 1 is a diagram of a system configured to process and exchange electronic transaction request messages in accordance with an example embodiment of the present disclosure;

FIG. 2 is a block diagram of a computing device that may be specifically configured in accordance with an example embodiment of the present disclosure;

FIG. 3 is a flow chart illustrating the operations performed, such as by the service provider of FIG. 1 embodied by the computing device of FIG. 2, in accordance with an example embodiment of the present disclosure;

FIG. 4 is a message flow diagram between various entities involved in an electronic transaction request according to an example embodiment of the present disclosure; and

FIG. 5 is another flow chart illustrating the operations performed, such as by the service provider of FIG. 1 embodied by the computing device of FIG. 2, in accordance with an example embodiment of the present disclosure.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A computing device, method, and computer program product are provided in accordance with an example embodiment in order to analyze an electronic transaction request message and to establish a response to the electronic transaction request message based on information available related to specific elements of the electronic transaction request message. For example, in instances in which the electronic transaction request message is for a product being sold at a retail establishment for which a discount may be available, example embodiments provided herein may analyze the electronic transaction request, provide details regarding the request to a request processor for adjudication of the request, which may return a discounted, net-price of the product. Embodiments may process the adjudicated request to instruct the retail establishment of the net price after the discount for the product to be collected from a recipient for the product. Embodiments may also submit a discount reimbursement request to a manufacturer or provider of the product, and receive the discount reimbursement from the manufacturer or provider of the product. The discount may then be passed along, in whole or in part, to the retail establishment to make the retail establishment whole for the product they have sold which may have been obtained by the retail establishment at a cost higher than the discounted price to the recipient of the product.

A computing device, method and computer program product are provided in accordance with an example embodiment in order to process and analyze incoming electronic transaction request messages, provide messages to one or more request processors, provide messages to a retail establishment and a manufacturer/distributor to facilitate a retail transaction and to validate the application of discounts or rebates. Embodiments may further facilitate the processing of payments to the retail establishment by a recipient of the product, and to make whole the retail establishment through collection of the discount value from the manufacturer/distributor and providing the payment to the retail establishment. In this manner, example embodiments provided herein facilitate retail transactions and pass through price reductions/discounts to a consumer while ensuring that the reduced price is not absorbed improperly throughout the transaction.

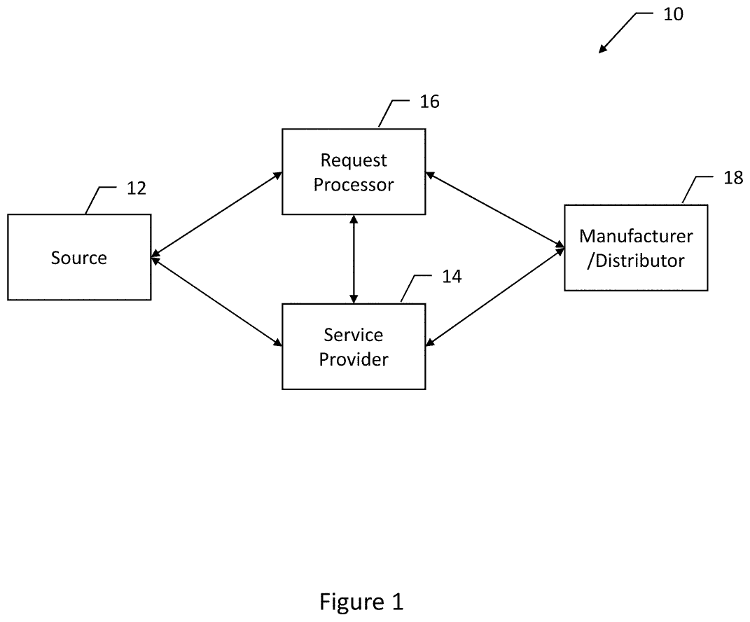

By way of example, a system 10 that is configured to analyze electronic transaction request messages and to construct related messages based upon the analysis of the electronic transaction request messages to facilitate a discounted price of a product for a consumer while compensating the retail establishment for the discount provided is depicted in FIG. 1. As shown, the electronic transaction request message may be provided by a source 12 and received by a service provider 14 and/or a request processor 16, either of which may be embodied as a switch. According to some embodiments, after analyzing the electronic transaction request message provided by the source and constructing a related message with reference to the contents of the electronic transaction request message, the request processor 16 may be configured to communicate with the service provider 14. Although the method, computing device and computer program product may be employed in various applications, the method, computing device and computer program product of example embodiments are employed in conjunction with the analysis of electronic transaction request messages and the construction of related messages or entering data/information into the electronic transaction request message in conjunction with telecommunication applications, content delivery and provisioning and healthcare products, such as in conjunction with the submission and evaluation of prescription claims for fulfillment, such as a prescription transaction request claim submitted by a pharmacy, and the provision of feedback regarding a discount available for the requested product. The service provider 14 of various embodiments may be in communication with a manufacturer/distributor 18 that produced and/or distributed the product, and the service provider may submit a reimbursement request to the manufacturer/distributor 18 for the discount given on the product. The service provider 14 may then provide reimbursement of the discounted amount to the pharmacy. According to some embodiments, the service provider 14 may accumulate electronic transaction data and periodically, such as every two weeks, provide a reimbursement request to the manufacturer/distributor 18 for the cumulative discounts along with invoice information identifying the electronic transactions that made up the cumulative discount.

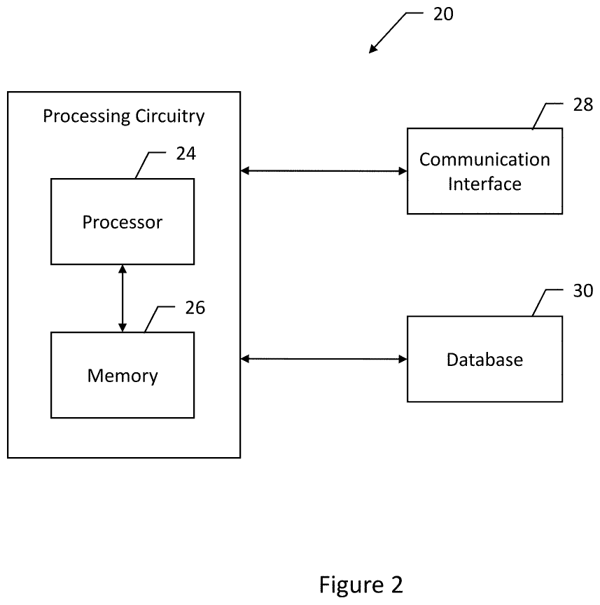

The service provider 14 may be configured in various manners, but, in embodiment, the service provider includes a computing device 20 configured to parse and differently process different portions of an electronic message and may be embodied as shown in FIG. 2. In this regard, the computing device that embodies the service provider may include or otherwise be in communication with a processing system including, for example, processing circuitry 22 that is configurable to perform actions in accordance with example embodiments described herein. The processing circuitry may be configured to perform data processing, application execution and/or other processing and management services. The processing circuitry may include a processor 24 and memory 26 that may be in communication with or otherwise control a communication interface 28 and a database 30. The computing device may also include the communication interface and the database as shown in FIG. 2, or the communication interface and/or the database may be separate from, but in communication with, the computing device.

In an example embodiment, the memory 26 may include one or more non-transitory memory devices such as, for example, volatile and/or non-volatile memory that may be either fixed or removable. The memory may be configured to store information, data, applications, instructions or the like for enabling the computing device 20 to carry out various functions in accordance with example embodiments of the present invention. For example, the memory could be configured to buffer input data for processing by the processor 24. Additionally or alternatively, the memory could be configured to store instructions for execution by the processor.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry) specifically configured to perform operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

The communication interface 28 may include one or more interface mechanisms for enabling communication with the request processor 16 and other entities 18. In this regard, the communication interface may include, for example, an antenna (or multiple antennas) and supporting hardware and/or software for enabling the communications therewith.

The database 30 may be embodied by any of a variety of data storage devices such as a Network Attached Storage (NAS) device or devices, or as a separate database server or servers. The database includes information accessed and stored by the processing circuitry 22 to facilitate the operations of the service provider 14. For example, the database may comprise a series of tables configured to store information regarding different types of messages and/or portions of different types of messages as described below.

While the aforementioned embodiments have been described generally with respect to electronic transaction request messages, and while these messages may be used for request for a variety of products for which discounts may be available to consumers, embodiments described herein may be particularly applicable to healthcare transactions, and specifically, prescription filling transactions performed at a pharmacy or remotely from a mail order pharmacy or specialty pharmacy.

Pharmaceutical transactions involving patients, pharmacies, prescription benefits managers, and pharmaceutical companies are often complex due to the pricing models that have been adopted by the healthcare industry. Pharmacy benefits managers may contract with pharmaceutical companies to improve sales of a prescription through preferred placement in a formulary. When a patient brings a prescription to a retail pharmacy, the retail pharmacy may submit a healthcare claim for payment. A pharmacy benefits manager may adjudicate the claim to identify patient responsibility or patient's share of the cost of a prescription including any applicable discounts. A patient may pay the retail pharmacy according to the patient's defined benefit plan, and the pharmacy benefits manager may charge the pharmaceutical manufacturer according to the rebate or kick-back with respect to filling the prescription. In this manner, the patient may not receive the benefit of the net-of-rebate discounted price, and may pay list price, particularly until a deductible is met, and then at a cost-share with the healthcare plan. This may result in a consumer or recipient of the prescription not realizing the full benefit of a rebate, while possibly discouraging the patient from filling the prescription, at which point the transaction ceases and no payment changes hands.

Regulatory agencies may define how pharmaceutical transactions may take place, thereby restricting the types of transactions and the payments. For example, pharmaceutical manufacturer rebates may only be permitted if they are applied as a fully transparent discount, separate and distinct from a patient's plan coverage and copay, to lower the up-front cost of the medication at the point of sale. Such regulation may ensure that appropriate rebates are passed on to consumers and not held for the benefit of a pharmacy benefits manager.

Given the present structure for identifying and processing rebates, changing how rebates are processed and redeemed is not a trivial matter and requires substantial changes to current workflows and processes. There are operational and technical challenges which must be overcome to implement fully transparent rebates that are passed along to a consumer in their entirety. The financial, operational, and technical challenges could negatively impact a dispensing pharmacy. Each “paid” prescription claim response from a pharmacy benefits manager or plan is a financial transaction that represents a single receivable to a pharmacy's accounts receivable system for which that pharmacy's reconciliation process expects to receive and balance against a single payment.

Generally, when a secondary payment is available for a prescription fill, such as through a manufacturer rebate or coupon/discount, a pharmacy may need to submit a separate secondary coordination of benefits (COB) claim to an alternate payer/processor. However, when there is a secondary payment for the same primary claim, such as a pharmaceutical manufacturer discount, a pharmacy's accounts receivable and reconciliation system cannot balance a second payment against that primary claim. This prevents a pharmacy from being able to process these payments and balance its account with legacy systems implementing new regulatory requirements.

Beyond the complexities of the pharmacy's accounts receivable system, of the available NCPDP (National Council for Prescription Drug Programs) billing claim response fields that could be used to reflect such a secondary pharmaceutical manufacturer discount payment, many pharmacy practice management systems are not coded to recognize those fields as receivables. As a result, the pharmacy may see these as under-funded claims that the pharmacy is dispensing at a loss.

Pharmaceutical benefits managers and processors currently submit rebate requests to pharmaceutical manufacturers for claims that are not eligible for such discounts, or where another pharmaceutical benefits manager has already applied for a rebate, and the second pharmaceutical benefits manager should not be submitting a request for a duplicate discount. Presently, these rebate requests are handled through a back-end system and processed quarterly, such that pharmaceutical manufactures have time to dispute and resolve such ineligible rebate request before payment is made. However, in a scenario in which these rebates can only be applied up-front at a point-of-sale as may be required by regulatory bodies, the patient or recipient would immediately receive all such discounts and a pharmacy would have receivables on their books for the applied discount. There is no lag time to validate the payments. Accordingly, the discounts must be validated and identified in real-time as the claim is being processed.

To facilitate example embodiments described herein, several levels of detailed reporting will be needed to support the process change. Pharmaceutical manufacturers may require claim-level detail reports from the entity responsible for tracking and/or facilitating the disbursement of these discount funds to the dispensing pharmacies to substantiate the payments. Pharmacies may require similar claim-level reporting in a standard electronic remittance file format (e.g., EDI 835) to validate that the remittance of payments ties to the corresponding receivables entries in their accounts receivable system. A regulatory body may further require a level of reporting to substantiate the amount for rebates or discounts the pharmaceutical manufacturers are paying in order to ensure that any relevant regulations are adhered to.

Due to the challenges described above, separate secondary payments to a primary claim are not a common practice such that pharmacies, along with their accounts receivable and reconciliation systems are not coded to or configured to handle such separate secondary payments. Embodiments provided herein mitigate the issues raised by the submission of ineligible claims for rebates when it is needed in real time as opposed to the current process in which rebate requests are submitted/disputed/resolved approximately sixty days following the close of a quarter.

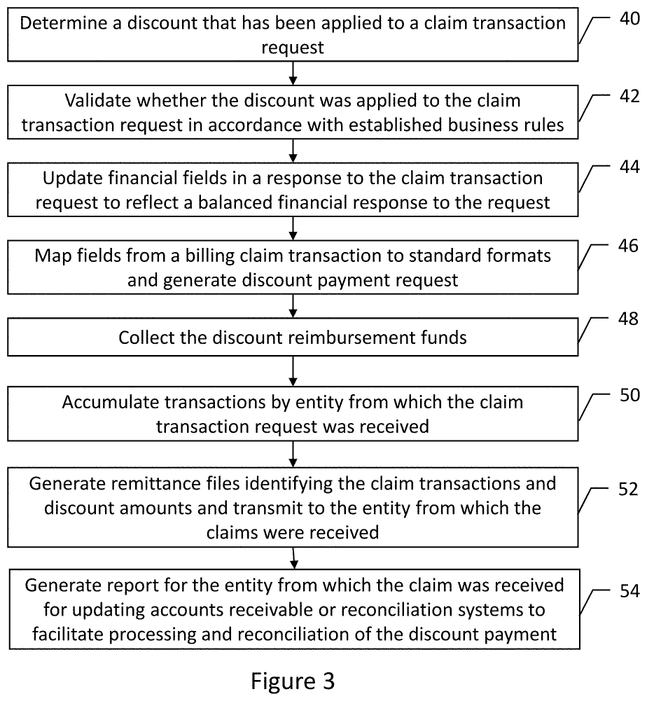

Embodiments described herein work in concert with pharmaceutical manufacturers and pharmacies for a transparent solution to determine the appropriate discount to be applied to each claim or to identify the discount amount calculated by another entity such as the pharmaceutical benefits manager or patient plan and populated in specific fields of a prescription claim transaction. FIG. 3 illustrates an example embodiment of a method for processing and verifying discounts applied to a claim transaction request.

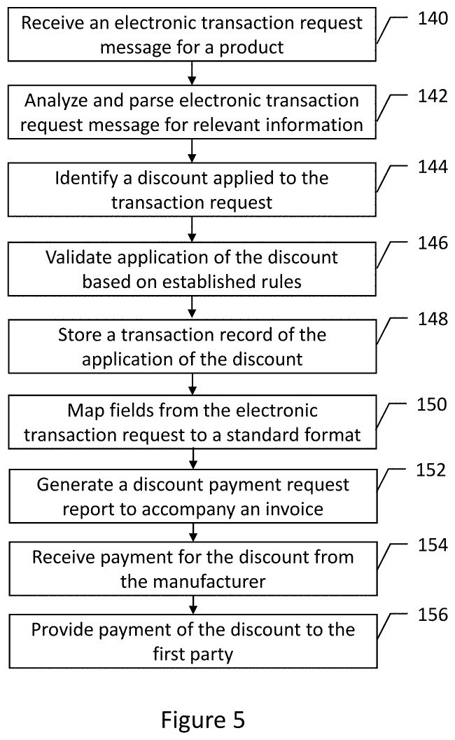

FIGS. 3 and 5 are flowcharts illustrating the operations performed by a method, apparatus and computer program product, such as computing device 10 of FIG. 2, in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 16 of a computing device employing an embodiment of the present invention and executed by a processor 14 of the computing device. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 3 and 5, when executed, convert a computer or processing circuitry into a particular machine configured to perform an example embodiment of the present invention. Accordingly, the operations of FIGS. 3 and 5 define an algorithm for configuring a computer or processing circuitry, e.g., processor, to perform an example embodiment. In some cases, a general purpose computer may be provided with an instance of the processor which performs the algorithm of FIGS. 3 and 5 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions. In some embodiments, certain ones of the operations above may be modified or further amplified and additional optional operations may be included. It should be appreciated that each of the modifications, optional additions or amplifications below may be included with the operations above either alone or in combination with any others among the features described herein.

A transaction request may be initially generated by a retail establishment 12 and provided to, for example, a request processor 16 and/or a service provider 14. The electronic message may take many forms depending upon the application. For example, the electronic transaction request message may be a message provided in conjunction with a telecommunications application that requests information from a recipient sufficient to permit a telecommunications connection to be established. Alternatively, the electronic transaction request message may be a request for content with conjunction with a content delivery and provisioning application. As yet another example, the electronic transaction request message may be a prescription fulfillment request from a pharmacy (e.g., a retail pharmacy, mail order pharmacy, or specialty pharmacy) to be processed and adjudicated to establish patient responsibility for fulfilling the prescription at a point of sale to a patient such that they are not charged too much for the prescription, which may result in a patient declining fulfilment and not being in compliance with their prescribers orders. Establishing appropriate patient responsibility for a prescribed product may increase the likelihood that the patient will have the prescription filled. Thus, the electronic transaction request message may be processed to establish a cost of the prescription along with any available discounts to the patient.

Regardless of the type of electronic transaction request message, the electronic transaction request message may be generated by source 12. For example, in an embodiment in which the electronic message is a prescription fulfillment request message, the electronic transaction request message may be generated by a system operated or controlled by the retail establishment or an intermediary, such as a pharmacy or the like. The transaction request message may be directed to request processor 16, such as a pharmacy benefits manager as described below; however, the transaction request message may also be received by a service provider 14, either from the source 12 or from the request processor 16.

The operations performed by the computing device 20 embodied by the service provider 14 are depicted in the example embodiment of FIG. 3. According to an example embodiment of the present disclosure, the computing device 20 also includes means, such as the processing circuitry 22, the processor 24 or the like, for establishing the appropriate discount to apply to a transaction at block 40, which may be performed based on a specified combination of National Drug Code (NDC) identifying the medication, pharmacy identifier indicating the pharmacy for fulfillment, and prescription plan or contract identifiers indicating the institutional payor. Information regarding the discount may be populated in one or more NCPDP financial fields, such as the “other payer amount recognized” or “other amount paid / other amount paid qualifier.” Optionally, using the values specified in the claim transaction, the discount amount may be identified if it has been populated by another entity, such as the pharmaceutical benefits provider or the patient's plan.

According to embodiments described herein, once the discount is known, as shown at block 42, the computing device 20 also includes means, such as the processing circuitry 22, the processor 24 or the like, for validation to establish if the discount has been applied in accordance with business rules established with the pharmaceutical manufacturer. A claim transaction record of the discount may be stored for subsequent real-time validation and reporting. Violations of the pharmaceutical manufacturer's business rules may be identified at this stage, such as discounts applied to claims from specifically excluded pharmacy national provider identifiers, duplicate discounts applied by two distinct payers for the same prescription fill, and either: A) record an exception error for the claim transaction that violated the business rule; or B) where possible, prevent the exception error in real time via the switch, such as via a combination of reversing the claim to the pharmaceutical benefits manager or processor with the corresponding error messaging and formatting a rejected claim response to the pharmacy specifying the error condition and any steps that could be taken to resolve the error.

According to some embodiments, where applicable and at the direction of the pharmacy of the transaction request, such as when the response as populated by the pharmaceutical benefits manager or processor would reflect an underfunded claim in the practice management system of the pharmacy, update the financial fields in the claim transaction response to report that discount amount in fields that will reflect a balanced financial response and appear as a fully funded claim, as shown in block 44.

Based on the established discount amount that is established, the fields in the transaction request may be mapped from the NCPDP billing claim transactions to the corresponding standard formats required by the pharmaceutical manufacturer, such as the NCPDP manufacturer rebate standard as shown at block 46. A discount payment request report may be generated for the billing period as substantiating detail to accompany an invoice to the pharmaceutical manufacturer. The funds for the discount may be collected at block 48 from the pharmaceutical manufacturer to facilitate payment to the pharmacies that submitted the corresponding discount claims.

The claim transaction requests may be segregated based on the entity from which the request was received, as shown at block 50. In this manner, the claim transaction requests may be segregated or accumulated according to individual pharmacies, pharmacy chains, or other contracted entity such as a buying group. A remittance file may be generated as shown at block 52 that specifies the claim transactions and discount amounts for which an aggregated payment is being made. This may be in the form of an EDI 835 remittance file format, for example. The remittance file and the associated funds identified in the remittance file may be transmitted o the pharmacy or other appropriate entity within an established time frame. The time frame may be, for example, every two weeks.

Where applicable, and to assist with a pharmacy's accounts receivable or reconciliation processing of a secondary discount payment against the primary claim, the amount of the pharmaceutical manufacturer's discount attributed to each primary claim may be identified and a report generated in the format specified by the recipient pharmacy or contracted entity used to update the accounts receivable or reconciliation systems as shown at block 54. The pharmacy or contracted entity may use this report to update a respective accounts receivable or reconciliation system to facilitate processing and reconciliation of the discount payments. A report may be generated in the appropriate format to support each pharmaceutical manufacturer's reporting requirements for any relevant regulatory agency.

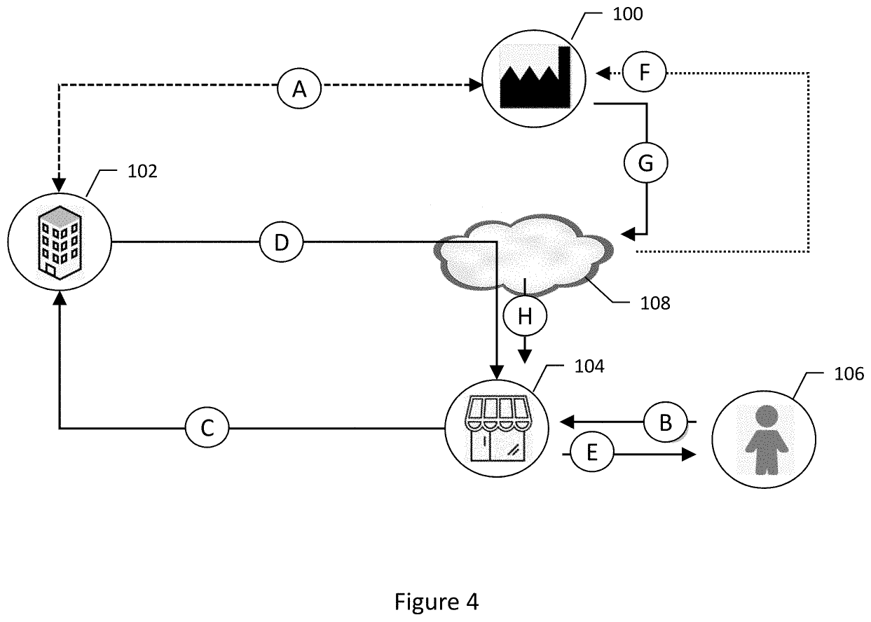

FIG. 4 illustrates an example embodiment of a service provider that may receive and process electronic transaction request messages and facilitate a point-of-sale discount. As illustrated, a manufacturer or distributor 100 may have a contractual relationship (A) with a request processor 102. While the illustrated embodiment may be generic to electronic transaction request processing in a retailer/consumer transaction, according to the embodiment described above with respect to prescription fulfillment requests, the manufacturer 100 may be a pharmaceutical company, while the request processor 102 may be a pharmaceutical benefits manager. In such an embodiment, the contractual arrangement between the pharmaceutical company and the pharmacy benefits manager may include contracts for discounts and formulary position or ranking within the pharmacy benefits managers preferred medication ranking.

A consumer 106 may make a request for purchase (B) at a retail establishment 104. This request for purchase may include the purchase of virtually any article. However, consistent with the aforementioned embodiment, the request for purchase may be a prescription fulfillment request (B) to a pharmacy 104. The retail establishment 104 may provide an electronic transaction request message and provide that message to request processor (e.g., pharmaceutical benefits manager) 102 (C). The request processor 102 may analyze and parse the message to establish an appropriate discount to be applied to the request. The analysis may be performed based on the national drug code identifier, pharmacy identifier, plan or contract identifiers, etc. and the discount may be populated in an adjudicated request by the request processor 102.

The request processor 102 may provide the adjudicated request message at (D) received by service provider 108. The service provider 108 may validate whether the discount has been applied in accordance with business rules established with the pharmaceutical manufacturer 100. This validation may identify any violations of the manufacturer's business rules, such as discounts applied to claims from excluded pharmacies or duplicate discounts applied by two distinct payers for the same prescription fill. The service provider 108 may record an exception error for the transaction that violated the business rule, or where possible, prevent the exception error in real time via a switch, such as by reversing the claim to the request processor 102 with a corresponding error message and formatting a rejected claim response to the retail establishment 104 indicating how the error may be resolved.

Using the claim transaction discount record of the validated adjudicated response, the service provider 108 may map the fields from the billing claim transaction to a corresponding standard format required by the manufacturer 100, such as the manufacturer rebate standard, and a discount payment request report for the billing period may be generated as substantiating detail to accompany an invoice to the manufacturer, which may be sent from the service provider 108 to the manufacturer 100 at (F). The service provider 108 may collect the discount funds at (G) from the manufacturer 100 and accumulate these discount funds, segregated according to retail establishment 104 or contracted entity (e.g., a chain of retail establishments). The service provider 108 may accumulate the discount funds on a per-entity basis over a predefined period of time, such as two weeks, and provide the accumulated discount funds to the retail establishment 104 at (H). The funds may be provided together with a generated remittance file that specifies the claim transactions and discount amounts that have been accumulated to facilitate reconciliation of the discounts with the retail establishment's accounts receivable such that each transaction request is reconciled without leaving transaction requests appearing under-funded.

FIG. 5 is a flowchart of a method for validating a discount for an electronic transaction request and reimbursing a retail establishment for the discount. As shown, an electronic transaction request message for a product is received from a first party at 140. The electronic transaction request is analyzed and parsed at 142 for information associated with the electronic transaction request. A discount applied to the transaction request is identified at 144.

Application of the discount is validated at 146 according to rules established fort the electronic transaction request. A record of the application of the discount to the electronic transaction request is stored at 148. The fields from the electronic transaction request are mapped to a standard format at 150. A discount payment request report is generated at 152 to accompany an invoice to a manufacturer. Payment is received at 154 for the discount from the manufacturer. Payment of the discount is provided to the first party at 156.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computing device configured to process electronic transaction request messages based upon an analysis of the message, the computing device comprising:
a communication interface configured to receive the electronic transaction request message from a first party for a product;
processing circuitry configured to:
analyze and parse the electronic transaction request message for information associated with the electronic transaction request;
identify a discount applied to the transaction request based on the information associated with the electronic transaction request;
validate application of the discount to the electronic transaction request based on rules established for the electronic transaction request;
store a transaction record of the application of the discount to the electronic transaction request;
map fields from the electronic transaction request to a standard format;
generate a discount payment request report to accompany an invoice to a manufacturer;
receive payment for the discount from the manufacturer; and
provide payment of the discount to the first party.

2. The computing device of claim 1, wherein the processing circuitry configured to generate the discount payment request report comprises processing circuitry configured to aggregate a plurality of transaction records and respective discounts and generate an aggregated discount payment request report to accompany an invoice for the plurality of transaction records to the manufacturer.

3. The computing device of claim 2, wherein the processing circuitry configured to provide payment of the discount to the first party comprises processing circuitry configured to provide payment of the plurality of discounts to the first party including a remittance report associating the discounts of the plurality of discounts to respective transaction records.

4. The computing device of claim 1, wherein the processing circuitry to identify the discount applied to the transaction request comprises processing circuitry configured to identify a discount within an adjudicated transaction request message.

5. The computing device of claim 1, wherein the first party is a pharmacy, and wherein the information associated with the electronic transaction request message comprises at least one of a National Drug Code (NDC), a pharmacy identifier, or a contract identifier.

6. The computing device of claim 1, wherein the processing circuitry configured to validate application of the discount to the electronic transaction request based on rules established for the electronic transaction request comprises processing circuitry to:
establish if the discount has been applied according to rules established by the manufacturer;
identify violations of the rules established by the manufacturer; and
reverse the electronic transaction request message in response to the identification of violations of the rules established by the manufacturer, wherein the reversal of the electronic transaction request comprises generating a rejection response specifying the error condition.

7. The computing device of claim 6, wherein the rejection response specifying the error condition further comprises an indication of how the error condition can be resolved.

8. The computing device of claim 1, wherein the processing circuitry configured to map fields from the electronic transaction request to a standard format comprises processing circuitry configured to map fields from the electronic transaction request to National Council for Prescription Drug Programs (NCPDP) manufacturer rebate standard format.

9. The computing device of claim 1, wherein the discount identified is a primary discount, wherein the processing circuitry is further configured to:
process a secondary discount payment against the electronic transaction request; and
generate a report to reconcile the primary discount payment and the secondary discount payment with the first party.

10. A computer program product configured to analyze an electronic transaction request message, the computer program product comprising a non-transitory computer readable medium having program code stored thereon, the program code comprising program code instructions configured, upon execution, to:
analyze and parse the electronic transaction request message for information associated with the electronic transaction request;
identify a discount applied to the transaction request based on the information associated with the electronic transaction request;
validate application of the discount to the electronic transaction request based on rules established for the electronic transaction request;
store a transaction record of the application of the discount to the electronic transaction request;
map fields from the electronic transaction request to a standard format;
generate a discount payment request report to accompany an invoice to a manufacturer;
receive payment for the discount from the manufacturer; and
provide payment of the discount to the first party.

11. The computer program product of claim 10, wherein the program code instructions to generate the discount payment request report comprises program code instructions to aggregate a plurality of transaction records and respective discounts and generate an aggregated discount payment request report to accompany an invoice for the plurality of transaction records to the manufacturer.

12. The computer program product of claim 11, wherein the program code instructions to provide payment of the discount to the first party comprises program code instructions to provide payment of the plurality of discounts to the first party including a remittance report associating the discounts of the plurality of discounts to respective transaction records.

13. The computer program product of claim 10, wherein the program code instructions to identify the discount applied to the transaction request comprises program code instructions to identify a discount within an adjudicated transaction request message.

14. The computer program product of claim 10, wherein the first party is a pharmacy, and wherein the information associated with the electronic transaction request message comprises at least one of a National Drug Code (NDC), a pharmacy identifier, or a contract identifier.

15. The computer program product of claim 10, wherein the program code instructions to validate application of the discount to the electronic transaction request based on rules established for the electronic transaction request comprises program code instructions to:
establish if the discount has been applied according to rules established by the manufacturer;
identify violations of the rules established by the manufacturer; and
reverse the electronic transaction request message in response to the identification of violations of the rules established by the manufacturer, wherein the reversal of the electronic transaction request comprises generating a rejection response specifying the error condition.

16. The computer program product of claim 15, wherein the rejection response specifying the error condition further comprises an indication of how the error condition can be resolved.

17. The computer program product of claim 10, wherein the program code instructions to map fields from the electronic transaction request to a standard format comprises program code instructions to map fields from the electronic transaction request to National Council for Prescription Drug Programs (NCPDP) manufacturer rebate standard format.

18. The computer program product of claim 10, wherein the discount identified is a primary discount, the computer program product further comprising program code instructions configured to:
process a secondary discount payment against the electronic transaction request; and
generate a report to reconcile the primary discount payment and the secondary discount payment with the first party.

19. A method for processing electronic transaction request messages based upon an analysis of the message, the method comprising:
analyzing and parsing the electronic transaction request message for information associated with the electronic transaction request;
identifying a discount applied to the transaction request based on the information associated with the electronic transaction request;
validating application of the discount to the electronic transaction request based on rules established for the electronic transaction request;
storing a transaction record of the application of the discount to the electronic transaction request;
mapping fields from the electronic transaction request to a standard format;
generating a discount payment request report to accompany an invoice to a manufacturer;
receiving payment for the discount from the manufacturer; and
providing payment of the discount to the first party.

20. The method of claim 19, wherein generating the discount payment request report comprises aggregating a plurality of transaction records and respective discounts and generating an aggregated discount payment request report to accompany an invoice for the plurality of transaction records to the manufacturer.
